(19) United States
(12) Patent Application Publication
(10) Pub. No.: US 2003/0209581 A1
(43) Pub. Date: Nov. 13, 2003

(54) Apparatus for transporting articles and method therefor

(76) Inventor: Larry D. Adams, McDonough, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/436,856

(22) Filed: May 13, 2003

Related U.S. Application Data
(60) Provisional application No. 60/380,221, filed on May 13, 2002.

(51) Int. Cl. B60R 7/00; B62J 7/00; B62J 9/00; B62J 11/00

(52) U.S. Cl. 224/413; 224/275

(57) ABSTRACT

An apparatus for transporting articles and method therefor having preferably two cradles attached to a support member or crossbar, wherein attachment mechanisms are positioned at the ends of the crossbar, proximal the base of each of the cradles, and wherein each attachment mechanism is dimensioned to receive a conventional motorcycle footrest and is provided with a locking pin to enable secure fastening thereto. The crossbar further possesses a seat slip, wherein the seat slip slides over the head/back rest of the motorcycle seat and secures the crossbar thereto, thus stabilizing the apparatus.

### CROSS-REFERENCE AND PRIORITY CLAIM TO RELATED APPLICATIONS

To the full extent permitted by law, the present application claims priority to and the benefit of the following application: 1) as a non-provisional application to provisional patent application entitled “Apparatus for Transporting Articles and Method Therefor”, filed on May 13, 2002, having assigned Ser. No. 60/380,221.

### TECHNICAL FIELD

The present invention relates generally to article carrying racks, and more specifically to an apparatus for transporting articles and method therefor. The present invention is particularly useful for, although not strictly limited to, transporting articles on two-wheeled vehicles.

### BACKGROUND OF THE INVENTION

Loading articles or luggage onto and/or into a vehicle can often prove a time-consuming and strenuous task. Although common luggage or article racks are available for mounting upon a vehicle's rooftop, such racks are generally ill-suited and/or incapable of being mounting onto two-wheeled vehicles. As such, the task of transporting articles upon such two-wheeled vehicles is difficult and often limits the quantity of luggage or articles a traveler may transport.

Luggage racks, article racks and/or saddlebags suited for attachment/mounting to a two-wheeled vehicle, such as a motorcycle, are usually an inconvenience, as they are often cumbersome and require a substantial amount of time to install. Moreover, detachment of such motorcycle racks usually requires the removal of a complex system of securing straps, buckles and/or locks therefrom, thus adding to the overall inconvenience of such racks and bags.

Furthermore, most available racks suitable for attachment to two-wheeled vehicles are disadvantageous, as their capacity to store large quantities of personal items is often limited or restricted to the small surface area and/or holding volume of the rack/luggage carrying unit used.

Therefore, it is readily apparent that there is a need for an apparatus for transporting articles and method therefor, wherein such an apparatus is capable of expeditiously attaching to and detaching from conventional two-wheeled vehicles with substantial ease, and wherein such an apparatus is capable of holding and securing therein a substantial quantity of personal items/luggage with, if desired, the assistance from various sized and specially designed containers that securely fit within the apparatus.

### BRIEF SUMMARY OF THE INVENTION

Briefly described, in a preferred embodiment, the present invention overcomes the above-mentioned disadvantages and meets the recognized need for such a device by providing an apparatus for transporting articles and method therefor, wherein such an apparatus is capable of expeditiously attaching to and detaching from conventional two-wheeled vehicles with substantial ease, and wherein such an apparatus is designed to hold, secure and carry therein a substantial quantity of personal articles, the volume of which may be increased via the use of various sized and specially designed containers that securely fit within the apparatus.

According to its major aspects and broadly stated, the present invention in its preferred form is an apparatus for transporting articles and method therefor having preferably two cradles attached to a common support member or crossbar, wherein the crossbar possesses attachment mechanisms for securing the apparatus to the rear footrests of a conventional motorcycle. The crossbar further possesses a seat slip, wherein the seat slip slides over the head/back rest of the motorcycle seat and secures the crossbar thereto, thus stabilizing the apparatus as a whole.

More specifically, the present invention is an apparatus for transporting articles and method therefor having preferably two cradles attached to a support member or crossbar, wherein attachment mechanisms are positioned at the ends of the crossbar, proximal the base of each of the cradles, and wherein each attachment mechanism is dimensioned to receive a conventional motorcycle footrest and is provided with a locking pin to enable secure fastening thereto. The crossbar further possesses a seat slip, wherein the seat slip slides over the head/back rest of the motorcycle seat and secures the crossbar thereto, thus stabilizing the apparatus.

A feature and advantage of the present invention is the ability to be expeditiously attached to and detached from a two-wheeled vehicle with substantially ease.

A feature and advantage of the present invention is its ability to hold a substantially greater amount of luggage or articles than conventional two-wheeled vehicle luggage/article racks.

A feature and advantage of the present invention is its ability to carrying an assortment of oversized articles, such as golf clubs, camping tents and/or large sports duffle bags.

A feature and advantage of the present invention is its portability.

A feature and advantage of the present invention is its simplicity of design.

A feature and advantage of the present invention is its ease of storage.

A feature and advantage of the present invention is its ease of manufacture.

A feature and advantage of the present invention is its light weight.

A feature and advantage of the present invention is its durability.

A feature and advantage of the present invention is its ability to be adapted to any two-wheeled vehicle.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a partial exploded view of an apparatus for transporting articles according to a preferred embodiment of the present invention;

FIG. 2 is a perspective view of an apparatus for transporting articles according to a preferred embodiment of present the invention;

FIG. 3 is a perspective view of an apparatus for transporting articles according to a preferred embodiment of the present invention showing how the apparatus attaches to the footrests of a motorcycle;

FIG. 4 is a perspective view of an apparatus for transporting articles according to a preferred embodiment of the present invention showing the apparatus in use; and,

FIG. 5 is a perspective view of a seat slip of an apparatus for transporting articles according to an alternate embodiment of the present invention.

### DETAILED DESCRIPTION OF THE PREFERRED AND ALTERNATIVE EMBODIMENTS

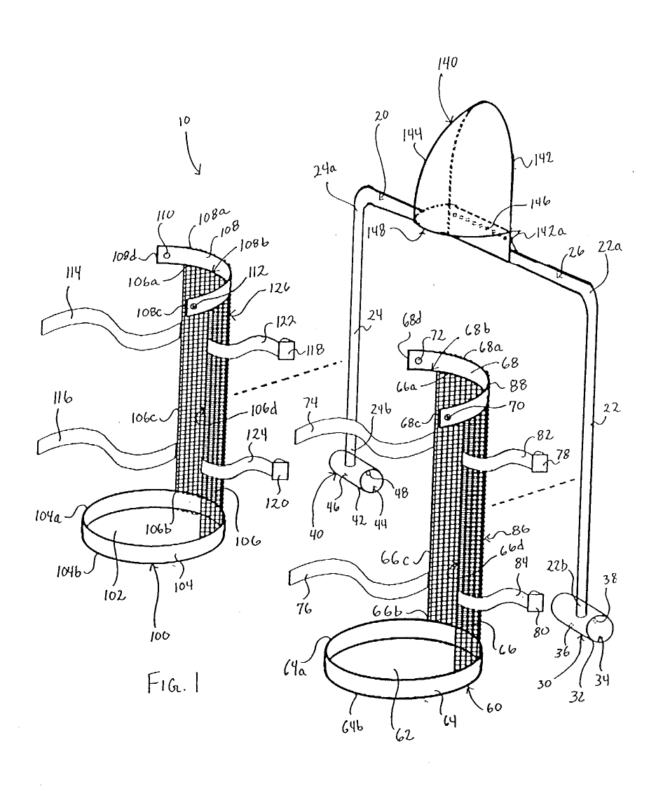

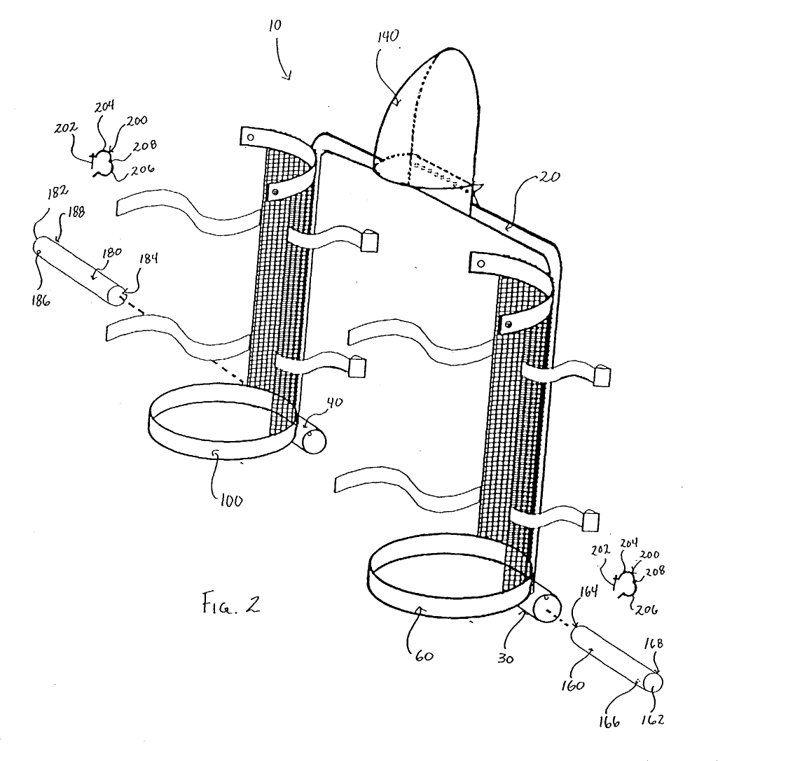

In describing the preferred and alternate embodiments of the present invention, as illustrated in FIGS. 1-5, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIG. 1-3, the present invention in its preferred embodiment is an apparatus 10, wherein apparatus 10 is an apparatus for transporting articles and method therefor generally having crossbar 20, cradles 60 and 100, seat slip 140, sleeves 160 and 180 and locking devices 200.

Crossbar 20 preferably defines an inverted U-shape and preferably has first arm 22, second arm 24 and third arm 26, wherein third arm 26 bridges first arm 22 and second arm 24. Crossbar 20 is preferably formed from a single cylindrical-shaped hollow rod of strong, yet lightweight, metal material, such as for exemplary purposes only, aluminum or titanium, and is preferably shaped via known metal bending/shaping means to form first arm 22, second arm 24 and third arm 26, thus giving crossbar 20 its overall inverted U-shape. Although metal is the preferred material of crossbar 20, other materials such as durable plastic, fiberglass or wood may also be utilized. Moreover, although first arm 22, second arm 24 and third arm 26 of crossbar 20 are preferably cylindrical-shaped, other suitable shapes, such as, for exemplary purposes only, rectangular, may be used. Furthermore, although formation of crossbar 20 from a single rod is preferred, crossbar 20 could be formed from more than one rod, wherein welds and/or hinges could attach first arm 22 and second arm 24 to third arm 26

First ends 22b and 24b of first arm 22 and second arm 24, respectively, have attachment mechanisms 30 and 40, respectively, formed thereon. Specifically, attachment mechanism 30 of first end 22b is preferably generally tubular-shaped receiving member 32, having aperture 34 formed therethrough and preferably two opposing, aligned throughholes 36 and 38 centrally positioned along the length of tubular-shaped receiving member 32. As more fully described below, throughholes 36 and 38 are preferably dimensioned to receive locking device 200, thereby enabling apparatus 10 to be secured to a rear footrest of any conventional motorcycle. Furthermore, aperture 34 is preferably designed and dimensioned to receive a conventional motorcycle footrest as more fully described below. Receiving member 32 is preferably formed from a strong, yet lightweight, metal material, such as for exemplary purposes only, aluminum or titanium, and is preferably welded to first end 22b of first arm 22 of crossbar 20, or may alternatively be integrally formed/molded thereto. Although metal is the preferred material of receiving member 32, other materials such as durable plastic, fiberglass or wood may also be utilized.

Similarly, attachment mechanism 40 of first end 24b of second arm 24 of crossbar 20 is preferably generally tubular-shaped receiving member 42, having aperture 44 formed therethrough and preferably two opposing, aligned throughholes 46 and 48 centrally positioned along the length of tubular-shaped receiving member 42. As more fully described below, throughholes 46 and 48 are preferably dimensioned to receive locking device 200, thereby enabling apparatus 10 to be secured to a rear footrest of any conventional motorcycle. Furthermore, aperture 44 is preferably designed and dimensioned to receive a conventional motorcycle footrest as more fully described below. Receiving member 42 is preferably formed from a strong, yet lightweight, metal material, such as for exemplary purposes only, aluminum or titanium, and is preferably welded to first end 24b of second arm 24 of crossbar 20, or may alternatively be integrally formed/molded thereto. Although metal is the preferred material of receiving member 42, other materials such as durable plastic, fiberglass or wood may also be utilized.

Preferably centrally positioned on and attached to third arm 26 of crossbar 20 is seat slip 140, wherein seat slip 140 preferably possesses flap 142 and attached sleeve 144 and is preferably formed from a pliable material such as, for exemplary purposes only, leather, suede and/or vinyl. Specifically, end 142a of flap 142 preferably generally encircles third arm 26 and is secured to flap 142 via rivets 146 or via any other known securing means, such as, for exemplary purposes only, adhesives, epoxies, resins, staples and/or snap-buttons for easy removal thereof. Sleeve 144 is preferably attached to flap 142 so as to form pocket 148, wherein pocket 148 is dimensioned to slip over the headrest or backrest of a conventional motorcycle seat as more fully described below. Although seat slip 140 is preferably formed from a pliable material, it is contemplated in an alternate embodiment that seat slip 140 could be formed or molded as a solid structure/casing from any suitable material, such as, for exemplary purposes only, durable plastic. Additionally, seat slip 140 could also be in the form of elastic straps and/or ties alone.

Cradle 60 is preferably generally semi-cylindrical-shaped and formed from a strong, yet lightweight, metal material, such as for exemplary purposes only, aluminum or titanium. Although metal is the preferred material of cradle 60, other materials such as durable plastic, fiberglass or wood may also be utilized. Cradle 60 preferably possesses generally circular-shaped tray 62, wherein tray 62 is preferably encircled by lip 64 and preferably serves to buttress articles placed thereon. Attached preferably to upper edge 64a of lip 64 is bottom edge 66b of wall 66, wherein wall 66 is preferably formed from a strong, yet lightweight, metal mesh material, such as for exemplary purposes only, mesh aluminum or mesh titanium sheets. Edge 66b of wall 66 is preferably welded to upper edge 64a of lip 64, but may alternatively be integrally formed/molded thereto or attached to any portion of lip 64 and/or tray 62. Although mesh metal is the preferred material of wall 66, other materials such as durable plastic, fiberglass or wood may also be utilized.

Preferably attached to upper edge 66a of wall 66 is base 68b of shoulder 68, wherein shoulder 68 is preferably generally semi-cylindrical shaped and preferably functions as a rest and/or support for articles placed thereon. Shoulder 68 preferably possesses throughholes 70 and 72 formed proximal to edges 68c and 68d, respectively, of shoulder 68, wherein throughholes 70 and 72 preferably function to receive string, straps, bungee cord, buckle-and-strap combination and/or tethers therein to secure articles carried on cradle 60.

Edge 66c of wall 66 preferably has straps 74 and 76 attached thereto, and edge 66d of wall 66 has straps 82 and 84 attached thereto. Straps 82 and 84 preferably possess buckles 78 and 80, respectively, wherein straps 74 and 76 are preferably received by buckles 78 and 80, respectively. The securing of straps 74 and 76 within buckles 78 and 80, respectively, preferably serves to secure articles placed within cradle 60, wherein buckles 78 and 80 are any securing buckles known within the art, and may alternatively be snaps, ties, hook-and-loop fasteners and/or other suitable securing means. Although the overall preferred shape of cradle 60 is semi-cylindrical, other shapes may be utilized, such as, for exemplary purposes only, rectangular or oval.

Cradle 60 is preferably attached to first arm 22 of crossbar 20 via any known attaching means, such as, for exemplary purposes only, welding. Specifically, backside 86 of wall 66 of cradle 60 is preferably attached to first arm 22 of crossbar 20 is such a manner that edge 64b of lip 64 of cradle 60 is positioned just above receiving member 32 of attachment mechanism 30.

Similarly, cradle 100 is preferably generally semi-cylindrical-shaped and formed from a strong, yet lightweight, metal material, such as for exemplary purposes only, aluminum or titanium. Although metal is the preferred material of cradle 100, other materials such as durable plastic, fiberglass or wood may also be utilized. Cradle 100 preferably possesses generally circular-shaped tray 102, wherein tray 102 is preferably encircled by lip 104 and preferably serves to buttress articles placed thereon. Attached preferably to upper edge 104a of lip 104 is bottom edge 106b of wall 106, wherein wall 106 is preferably formed from a strong, yet lightweight, metal mesh material, such as for exemplary purposes only, mesh aluminum or mesh titanium sheets. Edge 106b of wall 106 is preferably welded to upper edge 104a of lip 104, but may alternatively be integrally formed/molded thereto or attached to any portion of lip 104 and/or tray 102. Although mesh metal is the preferred material of wall 106, other materials such as durable plastic, fiberglass or wood may also be utilized.

Preferably attached to upper edge 106a of wall 106 is base 108b of shoulder 108, wherein shoulder 108 is preferably generally semi-cylindrical shaped and preferably functions as a rest and/or support for articles placed thereon. Shoulder 108 preferably possesses throughholes 110 and 112 formed proximal to edges 108c and 108d, respectively, of shoulder 108, wherein throughholes 110 and 112 preferably function to receive string, straps, bungee cord, buckle-and-strap combination and/or tethers therein to secure articles carried on cradle 100.

Edge 106c of wall 106 preferably has straps 114 and 116 attached thereto, and edge 106d of wall 106 has straps 122 and 124 attached thereto. Straps 122 and 124 preferably possess buckles 118 and 120, respectively, wherein straps 114 and 116 are preferably received by buckles 118 and 120, respectively. The securing of straps 114 and 116 within buckles 118 and 120, respectively, preferably serves to secure articles placed within cradle 100, wherein buckles 118 and 120 are any securing buckles known within the art, and may alternatively be snaps, ties, hook-and-loop fasteners and/or other suitable securing means. Although the overall preferred shape of cradle 100 is semi-cylindrical, other shapes may be utilized, such as, for exemplary purposes only, rectangular or oval.

Cradle 100 is preferably attached to second arm 24 of crossbar 20 via any known attaching means, such as, for exemplary purposes only, welding. Specifically, backside 126 of wall 106 of cradle 100 is preferably attached to second arm 24 of crossbar 20 is such a manner that edge 104b of lip 104 of cradle 100 is positioned just above receiving member 42 of attachment mechanism 40.

Sleeve 160 is preferably hollow and generally tubular-shaped, having closed end 162, open end 164 and throughholes 166 and 168 opposingly formed on sleeve 160 proximal to closed end 162. Similarly, sleeve 180 is preferably hollow and generally tubular-shaped, having closed end 182, open end 184 and throughholes 186 and 188 opposingly formed on sleeve 180 proximal to closed end 182. Open ends 164 and 184 of sleeves 160 and 180, respectively, are preferably each dimensioned to receive one rear footrest of any conventional motorcycle. Throughholes 166 and 168 of sleeve 160 preferably align with throughholes 36 and 38, respectively, of receiving member 32 of attachment mechanism 30, wherein aligned throughholes 36 and 166, and aligned throughholes 38 and 168, preferably receive pin 202 from locking device 200, as more fully described below. Similarly, throughholes 186 and 188 of sleeve 180 preferably align with throughholes 46 and 48, respectively, of receiving member 42 of attachment mechanism 40, wherein aligned throughholes 46 and 186, and aligned throughholes 48 and 188, preferably receive pin 202 from locking device 200, as more fully described below. Sleeves 160 and 180 are preferably formed from a strong, yet lightweight, metal material, such as for exemplary purposes only, aluminum or titanium. Although metal is the preferred material of sleeves 160 and 180, other materials such as durable plastic may also be utilized.

Locking device 200 preferably possesses pin 202 slidably engaged with C-shaped first arm 204, wherein first arm 204 is hingably attached to C-shaped second arm 206 via spring-loaded hinge member 208. Second arm 206 preferably possesses throughhole 210, wherein springful closure of locking device 200 urges pin 202 through throughhole 210, thus maintaining locking device 200 in a closed and locked position. Locking device 200 is preferably formed from a strong, yet lightweight, metal material, such as for exemplary purposes only, aluminum or titanium; although other materials could be used, such as, for exemplary purposes only, durable plastic, fiberglass or wood. It is contemplated in an alternate embodiment that locking device 200 could be any other suitable locking mechanism known with the art, such as, for exemplary purposes only, clevis pins, linch pins, cotter pins, clamps, spring clips and/or any other suitable locking and/or locking pin device. It is further contemplated in an alternate embodiment that conventional motorcycle footrests could be manufactured with preformed throughholes, thereby readily receiving locking device 200 of apparatus 10 or any other locking pins and/or similar device.

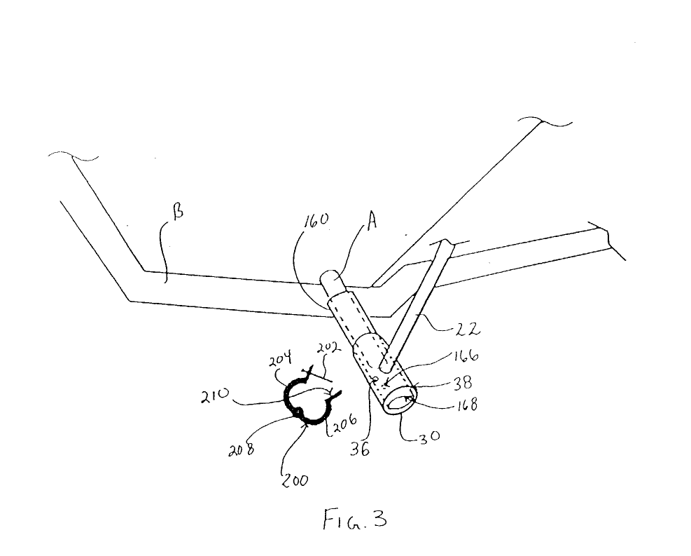

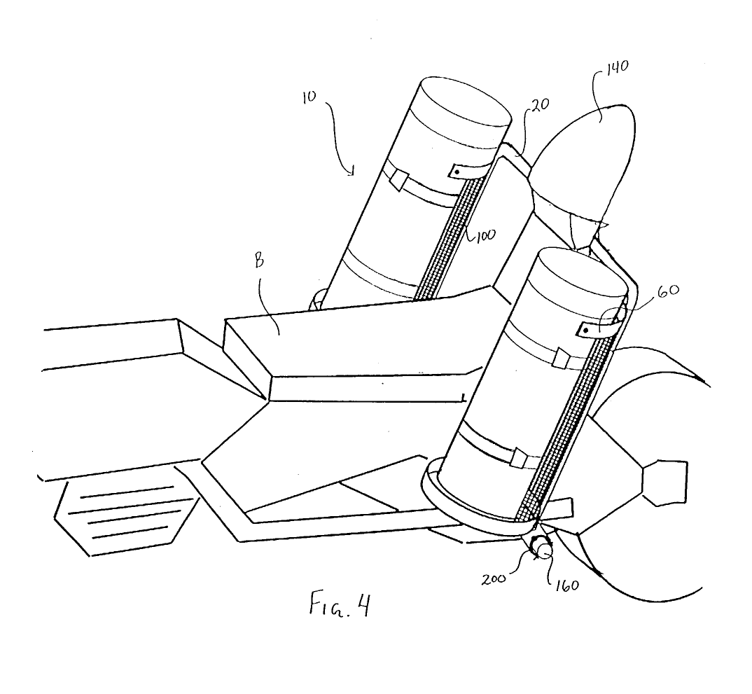

Referring now to FIGS. 3-4, in use, apparatus 10 is first straddled over a conventional two-wheeled vehicle, such as a motorcycle. Each of sleeves 160 and 180 are then preferably slid onto a corresponding rear footrest A of the motorcycle B. Thereafter, receiving members 32 and 42 of attachment mechanisms 30 and 40, respectively, are slid onto respective sleeves 160 and 180. Sleeve 160 is rotated so that throughholes 166 and 168 of sleeve 160 align with throughholes 36 and 38 of receiving member 32. Similarly, sleeve 180 is rotated so that throughholes 186 and 188 of sleeve 180 align with throughholes 46 and 48 of receiving member 42. Placement of receiving members 32 and 42 over sleeves 160 and 180, respectively, inherently results in the upward displacement of apparatus 10, wherein such displacement permits seat slip 140 to be slipped over the head/backrest of the motorcycle seat, thus securing crossbar 20 thereto and giving apparatus 10 greater stability. Thereafter, throughholes 36 and 46 of attachment mechanisms 30 and 40, respectively, each receive pin 202 of locking devices 200, wherein pin 202 of each locking device 200 is inserted through throughholes 166 and 186 of sleeves 160 and 180, respectively, and through throughholes 168 and 188 of sleeves 160 and 180, respectively, and thereafter through throughholes 38 and 48 of attachment mechanisms 30 and 40, respectively. After insertion of pins 202 through their respective throughholes, second arm 206 is springfully urged closed and throughhole 210 of second arm 206 receives pin 202, thus securely fastening locking devices 200 around each attachment mechanism 30 and 40. Upon completion of securing apparatus 10 to the motorcycle B, articles can be placed on trays 62 and 102 of cradles 60 and 100, respectively, and secured therein via tightening of the respective straps 74, 76, 82 and 84 and 114, 116, 122 and 124 with respective buckles 78, 84, 118 and 120 of cradles 60 and 100. Quick detachment of apparatus 10 from the motorcycle B simply entails removing locking devices 200 and slipping receiving members 32 and 42 from off sleeves 160 and 180, respectively.

Although the overall preferred shape of cradles 60 and 100 is semi-cylindrical, it is contemplated in an alternate embodiment that other shapes may be utilized, such as, for exemplary purposes only, rectangular or oval.

In another alternate embodiment, cradles 60 and 100 could possess hingably attached and lockable doors that could enclose luggage placed within cradles 60 and 100, thus giving cradles 60 and 100 an overall cylindrical shape.

In another alternate embodiment, walls 66 and 106 of cradles 60 and 100, respectively, could be formed from a non-mesh material.

In yet another alternate embodiment, crossbar 20 could be shaped and/or modified for use on any type of two-wheeled, three-wheeled and/or four-wheeled vehicle and/or to facilitate stabilization of crossbar 20 against a vehicle's seat/head/backrest.

In yet another alternate embodiment, it is contemplated that apparatus 10 could be modified in size and shape to accommodate any two-wheeled, three-wheeled and/or four-wheeled vehicle, or bicycle, snowmobile and/or jet ski.

In yet another alternate embodiment, attachment mechanisms 30 and 40 could be modified in shape and size to accommodate any style of footrest, wherein sleeves 160 and 180 would be modified accordingly.

In still another alternate embodiment, attachment mechanisms 30 and 40 could possess self-locking and/or self-latching mechanism so as to permit securement thereof to any motorcycle footrest without the use of locking devices 200.

In still another alternate embodiment, straps having hook-and-loop fasteners could replace the buckle-strap mechanism as described above.

In still another alternate embodiment, apparatus 10 could be equipped with any number of cradles.

In still another alternate embodiment, apparatus 10 could be equipped with support bars where desired to further stabilize apparatus 10 on a vehicle.

In still another alternate embodiment, seat slip 140 could be formed as a solid or hard covering and/or integrally formed with crossbar 20.

In still another alternate embodiment, seat slip 140 could be replaced by straps and/or locking latches.

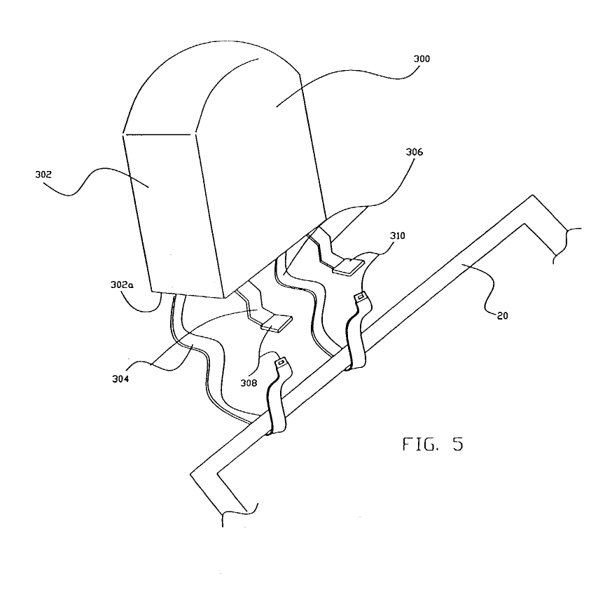

Referring specifically now to FIG. 5, according to an alternate embodiment, crossbar 20 could possess seat slip 300 instead of seat slip 140, wherein seat slip 300 has a sleeve portion 302 dimensioned to slidably engage any conventional head/back/seat rest of a conventional motorcycle seat. Sleeve portion 302 has straps 304 and 306 sewn to inside surface 302a of sleeve portion 302, wherein straps 304 and 306 loop around crossbar 20 and possess conventional buckle mechanisms 308 and 310, respectively, to enable seat slip 300 to be secured to a motorcycle head/back/seat rest.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. An article carrying apparatus for use on a vehicle, said article carrying apparatus comprising:
at least one support member;
at least one cradle carried by said support member;
means for securing said at least one support member to the vehicle; and,
means for securing the article(s) placed on said at least one cradle.

2. The article carrying apparatus of claim 1, wherein said means for securing said at least one support member is at least one seat slip carried by said at least one support member, said seat slip adapted to slip over the vehicle seat.

3. The article carrying apparatus of claim 1, wherein said means for securing said at least one support member is at least one locking device for releasably locking said support member to the vehicle.

4. The article carrying apparatus of claim 3, wherein said at least one locking device is a sleeve-and-spring-loaded-lock-pin combination adapted to secure said at least one support member to the vehicle.

5. The article carrying apparatus of claim 1, wherein said means for securing said at least one support member is at least one strap.

6. The article carrying apparatus of claim 1, wherein said means for securing the article(s) is at least one strap carried by said at least one cradle.

7. The article carrying apparatus of claim 1, wherein said means for securing the article(s) is at least one strap-and-buckle combination carried by said at least one cradle.

8. The article carrying apparatus of claim 1, wherein said at least one cradle comprises an elongated back wall secured to a base support.

9. An article carrying apparatus for use on a motorcycle, said article carrying apparatus comprising:
at least one support bar;
at least one cradle carried by said support bar;
means for securing said at least one support bar to the motorcycle;
at least one locking device for releasably locking said support bar to the motorcycle; and,
means for securing the article(s) placed on said at least one cradle.

10. The article carrying apparatus of claim 9, wherein said means for securing said at least one support bar is at least one seat slip carried by said at least one support bar, said seat slip adapted to slip over the motorcycle seat.

11. The article carrying apparatus of claim 9, wherein said means for securing said at least one support bar is at least one strap.

12. The article carrying apparatus of claim 9, wherein said at least one locking device is a sleeve-and-spring-loaded-lock-pin combination adapted to secure said at least one support bar to the footrests of the motorcycle.

13. The article carrying apparatus of claim 9, wherein said at least one locking device is a self-latching lock mechanism adapted to secure said at least one support bar to the footrests of the motorcycle.

14. The article carrying apparatus of claim 9, wherein said means for securing the article(s) is at least one strap carried by said at least one cradle.

15. The article carrying apparatus of claim 9, wherein said means for securing the article(s) is at least one strap-and-buckle combination carried by said at least one cradle.

16. The article carrying apparatus of claim 9, wherein said at least one cradle comprises an elongated back wall secured to a base support.

17. A method of carrying an article on a vehicle, said method comprising the steps of:
a. obtaining an article carrying apparatus, comprising:
at least one support member;
at least one cradle carried by said support member;
at least one locking device for releasably locking said support member to the vehicle frame; and,
at least one securing device for securing the article(s) placed on said at least one cradle;
b. placing said article carrying apparatus onto the vehicle;
c. locking said support member to the vehicle frame via said at least one locking device; and,
d. placing and securing articles within said at least one cradle.

18. The method of claim 17, wherein said at least one locking device is a sleeve-and-spring-loaded-lock-pin combination adapted to secure said at least one support member to the vehicle frame.

19. The method of claim 17, further comprising at least one seat slip carried by said at least one support member for securing said support member to the vehicle seat;

20. The carrying apparatus of claim 17, wherein said at least one securing device is at least one strap-and-buckle combination carried by said at least one cradle.
